(19) United States
(12) Patent Application Publication
(10) Pub. No.: US 2008/0155062 A1
(43) Pub. Date: Jun. 26, 2008

(54) System for providing media data

(76) Inventors: Andre Rabold, Ettlingen (DE); Axel Braun, Wiesbaden (DE); Harald Ruf, Waldkirch-Suggental (DE)

Correspondence Address: GLENN PATENT GROUP, 3475 EDISON WAY, SUITE L, MENLO PARK, CA, 94025, US

(21) Appl. No.: 11/925,098

(22) Filed: Oct. 26, 2007

Related U.S. Application Data
(60) Provisional application No. 60/864,139, filed on Nov. 2, 2006.

(51) Int. Cl. G06F 15/16

(52) U.S. Cl. 709/219

(57) ABSTRACT

Server apparatus (100) for providing media data to client devices (101 to 104) comprising a data interface (110) for communicating with the client devices (101 to 104). The server apparatus (100) further comprises a user interface (120) for receiving a client device identification and a controller (130) for selecting a client device (101) based on the client device identification. The server apparatus (100) further comprises a data forwarder (140) for providing the media data to the selected client device (101) through the data interface (110).

### CROSS-REFERENCE TO RELATED APPLICATIONS

This application claims priority to U.S. Provisional Patent Application No. 60/864,139 filed Nov. 2, 2006.

### DESCRIPTION

The present invention is in the field of multimedia devices as they are, for instance, used in home entertainment systems.

Present home entertainment systems support a large variety of different media formats. For example, multi-format players as DVD-players (DVD=Digital Versatile Disk), which also support audio CD (CD=Compact Disk), as well as multiple audio and video formats, e.g. MPEG (MPEG=Moving Pictures Expert Group) and the associated video and audio layers, are well established on the market. Moreover, multimedia personal computers are available in almost every household and they potentially provide support for a large variety of different multimedia formats as well. Apart from these mostly stationary devices, end users are equipped with mobile devices as, for example, cell phones, PDAs (PDA=Personal Digital Assistant), laptop computers, etc., which also support multiple multimedia data formats. Furthermore, multimedia applications as, for example, video services, which can be displayed on a television set as well as on a personal computer, are more and more dominant on the market.

Therewith, end users can utilize multiple devices in order to play-out multimedia data. For example, in order to watch a certain TV show, it may just be displayed on a television set in a traditional fashion, for example, received via cable, satellite or terrestrial signals. It may be displayed on a personal computer just as well as, for example, being received through IPTV (IPTV=Internet Protocol TeleVision). In a similar manner, the video streaming may be displayed on a cell phone or a PDA. Although users potentially have different choices for playing out multimedia data, present devices are autonomous, i.e. multimedia sessions carried out are individual and separated.

These conventional systems, for example, comprising TV sets, DVD players, multi-format players, personal computers, laptop computers, PDAs, cell phones, etc. do not allow to start a multimedia session on one device and continue the session on another device. For example, a user listening to a song on his cell phone, for instance, when walking home from work, is not able to seamlessly switch over the song from the cell phone to a stereo by the time he arrives home. In a similar example, a user watching a TV show on his personal computer cannot seamlessly switch over said TV show to his TV. The conventional systems, therewith, provide the disadvantage that only separated multimedia sessions can be carried out.

It is the objective of the present invention to provide an improved concept for playing out multimedia data on multiple devices.

The object is achieved by a server apparatus according to claim 1, a method for providing media data according to claim 11, a receiver apparatus according to claim 13, a method for receiving according to claim 18 and a system for providing media data according to claim 25.

This object is achieved by a server apparatus for providing media data to a client device, wherein the server apparatus comprises a data interface for communicating with the client devices and a user interface for receiving a client device identification. The server apparatus further comprises a controller for selecting a client device based on the client device identification and a data forwarder for providing the media data to the selected client device through the data interface.

The object is further achieved by a receiver apparatus for receiving media data from a server device and for providing the media data to a play-out device. The receiver apparatus comprises a data interface for communicating with the server device and for receiving the media data, it further comprises a user interface for receiving a user information. The receiver apparatus further comprises a means for processing the media data for adaptation to the play-out device and a play-out interface for providing the media data to the play-out device, wherein the means for processing is further adapted for controlling the data interface and the play-out interface based on the user information.

The present invention is based on the finding that a server apparatus can take over a central role in a home environment network. The server apparatus can either receive multimedia data as, for example, from video broadcasting as DVB-T (DVB-T=Digital Video Broadcast Terrestrial), DVB-H (DVB-H=DVB-Handheld), DVB-C (DVB-C=DVB-Cable), DVB-S (DVB-S=DVB-satellite), via other satellite communication, via the Internet, etc. or, alternatively, provide multimedia data from a storage device as, for example, from an internal or external hard drive. Optionally, the server apparatus may comprise another interface for communicating with a storage device. Since the server apparatus is a central node in the home environment network, multimedia data, which is provided through the server, can be streamed to a client device, which, again, may be a TV set, a personal computer, a PDA, a cell phone, etc. Since the media data is provided through a central node, it can be seamlessly directed, copied or switched over between the devices. The devices, in turn, comprise receiver apparatuses for receiving the media data from the server device and for providing the media data to a play-out device. The play-out devices, again, may be a TV set, a cell phone, a PDA, a PC, etc.

In embodiments, said receiver apparatuses may be integrated in the play-out devices. Since the server apparatus is central, multimedia sessions can be stopped, paused, continued, redirected, copied, i.e. parallel sessions are enabled, etc. Moreover, a user can be enabled to communicate with said server apparatus through a user interface either directly at the server or at the client devices. In embodiments, the server apparatus may be configurable to provide certain multimedia data only to certain devices or to authenticated users. Embodiments of the present invention, therewith, provide the advantage that parental control can be enabled in a home environment, where a server apparatus can be fully configured, for example, for parental control, monitoring or time-shifting purposes. Since multimedia data is administered and received at the server apparatus, multimedia content can easily be stored once it is received.

After having stored multimedia content, the server can provide time-shifted content. This enables embodiments to provide an end-user with the flexibility of stopping an on-going multimedia session, for example, when watching the news and continue said session at any later point in time. The server may buffer or store a multimedia session, i.e. the news video stream, which the end user can continue at a later point in time. For example, the multimedia session can be paused and then continued on a mobile device when an end user leaves the home environment, for example.

Embodiments of the present invention will be detailed using the accompanying Figs. in which:

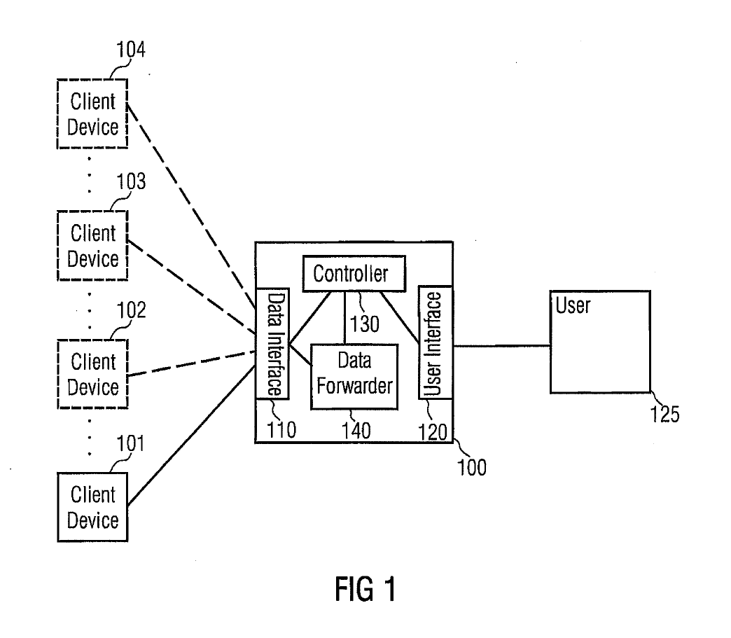

FIG. 1 shows an embodiment of a server apparatus;

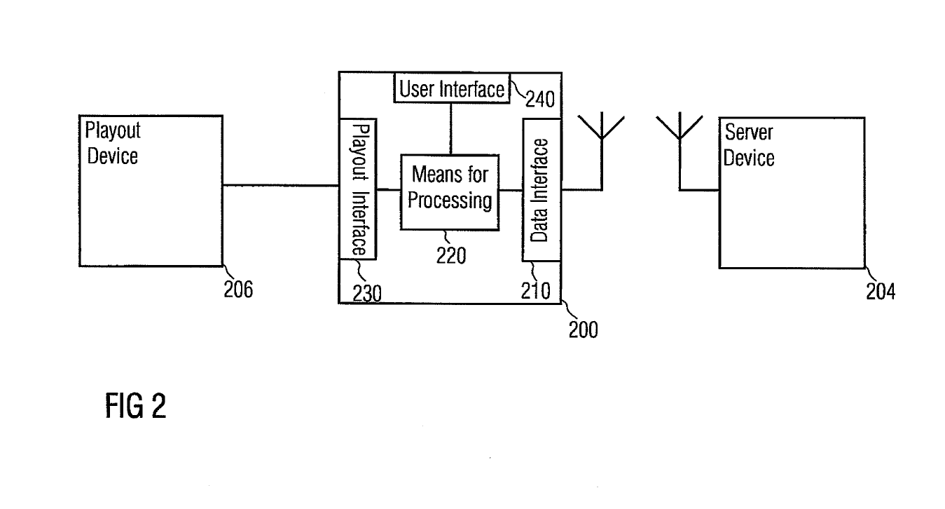

FIG. 2 shows an embodiment of a receiver apparatus;

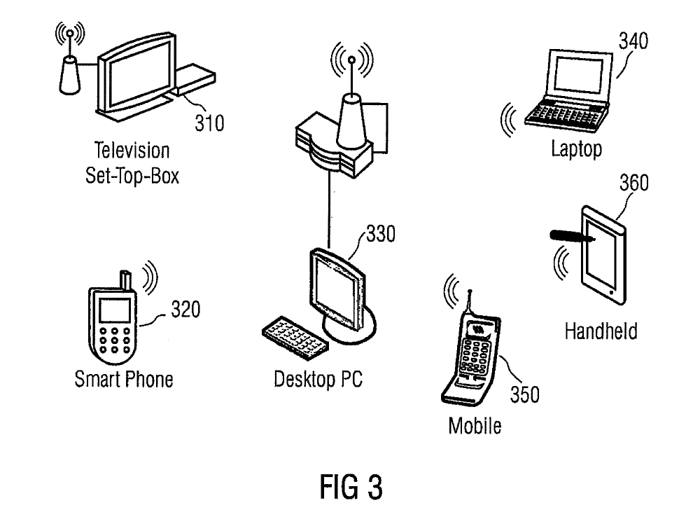

FIG. 3 shows an example scenario in a home environment;

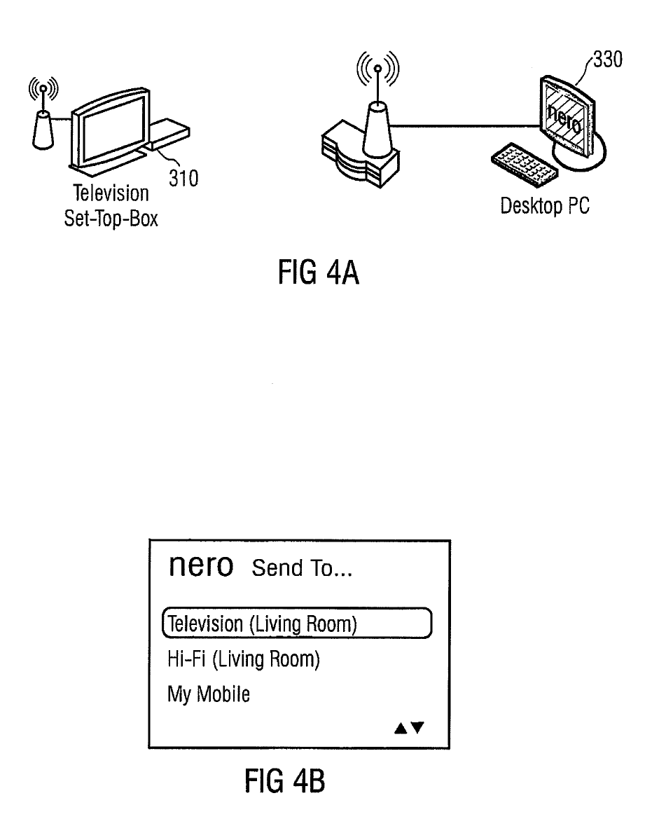

FIG. 4 illustrates an example of a use case;

FIG. 4b illustrates an example of a selection screen;

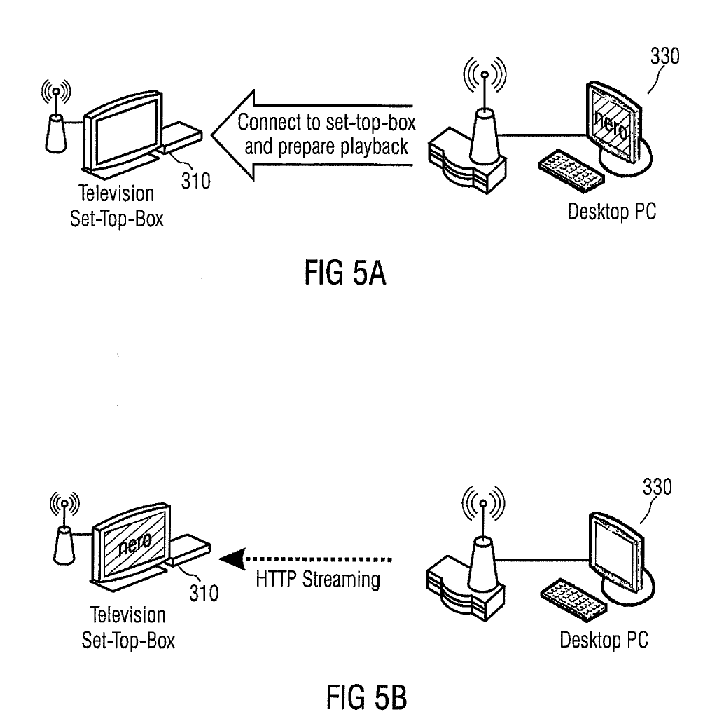

FIG. 5a shows an example of a set-up scenario for a multimedia session;

FIG. 5b shows an example for a streaming scenario;

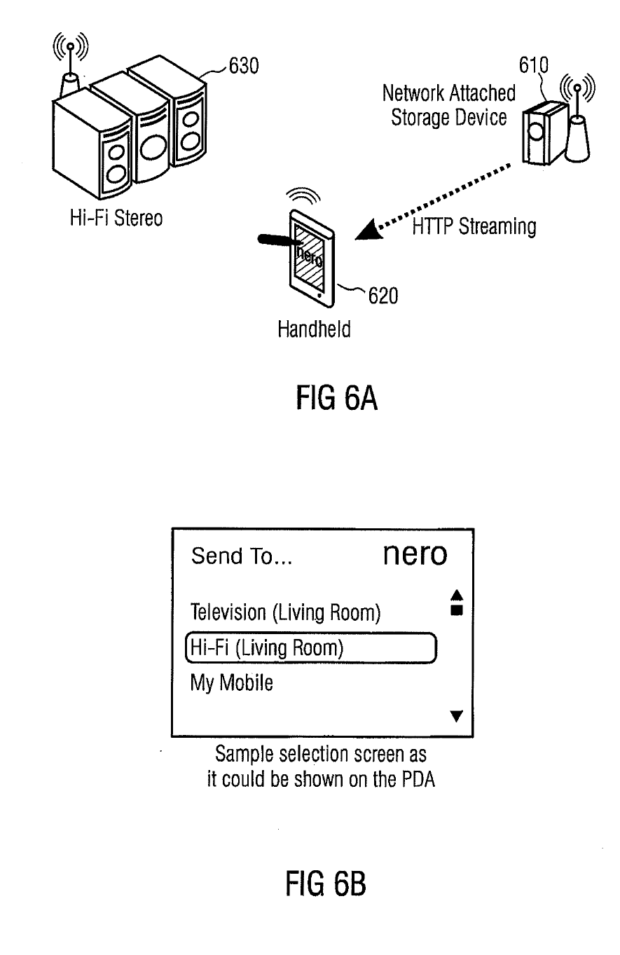

FIG. 6a shows an example for a redirection scenario;

FIG. 6b shows an example for a selection screen;

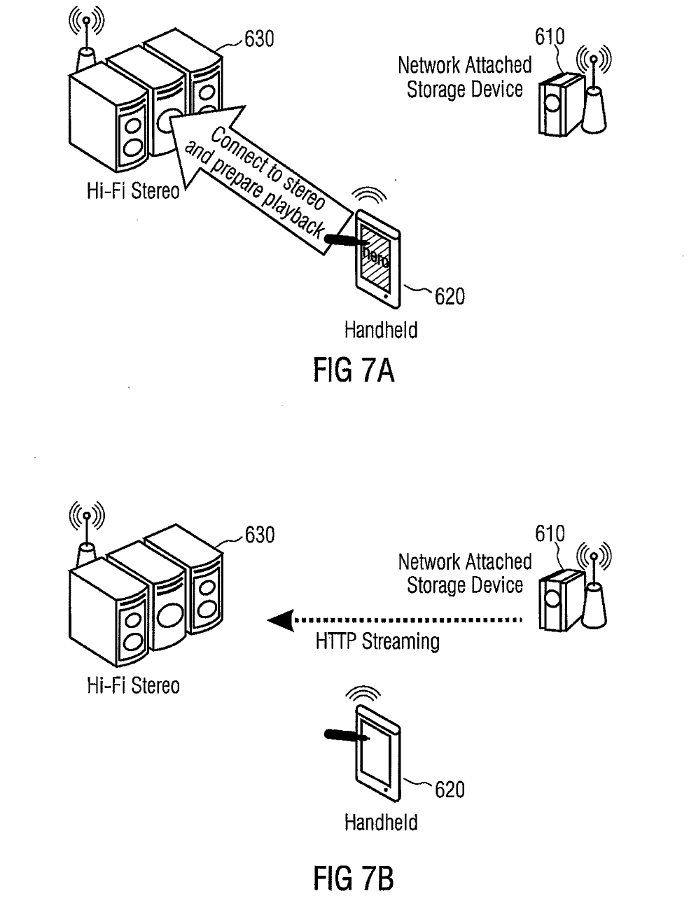

FIG. 7a further illustrates an example of a redirection scenario;

FIG. 7b further illustrates an example of a redirection scenario;

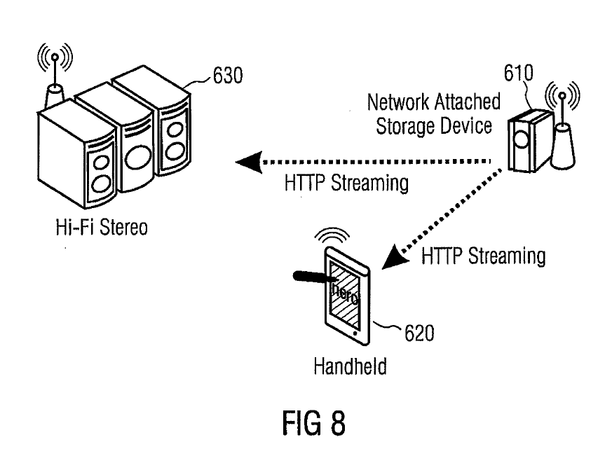

FIG. 8 illustrates an example of a parallel session scenario;

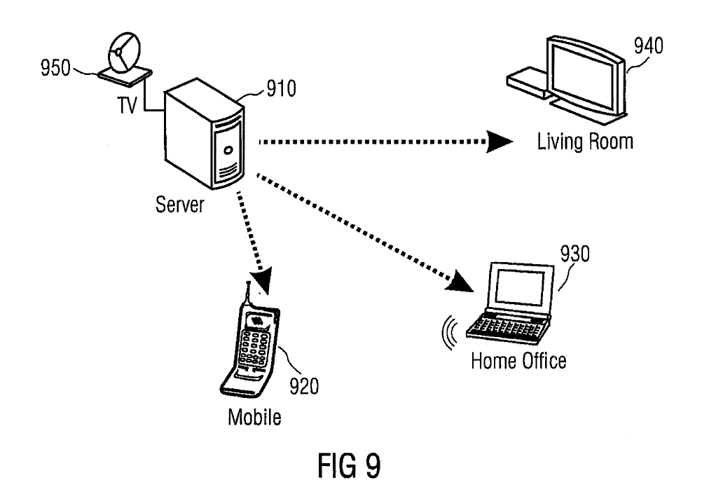

FIG. 9 illustrates another example for a parallel session scenario;

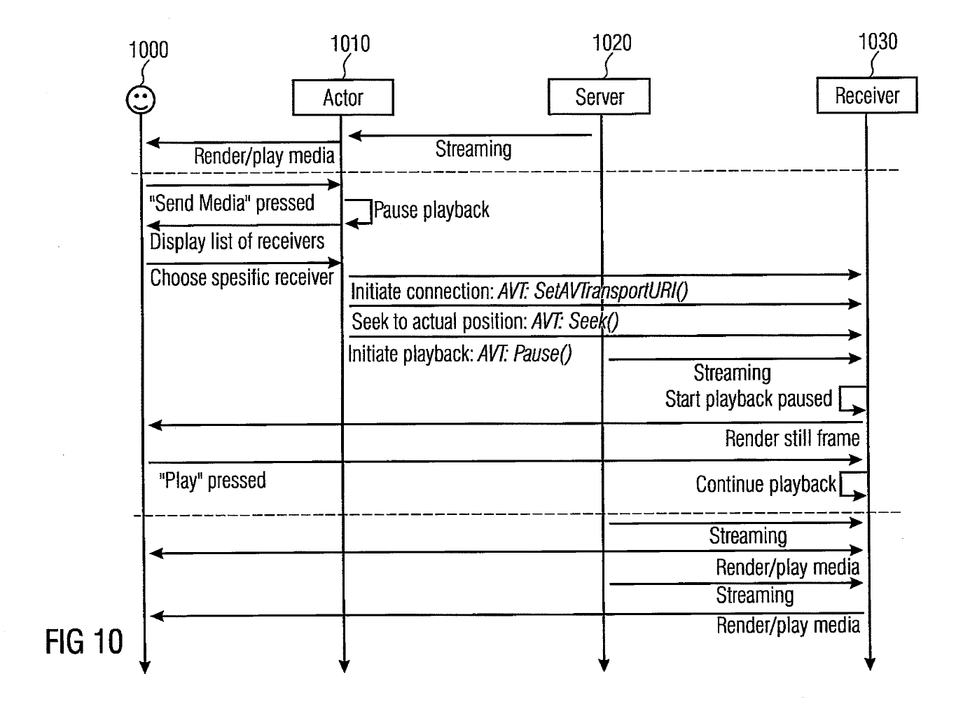

FIG. 10 shows a message sequence chart for an example communication when redirecting a multimedia stream, and

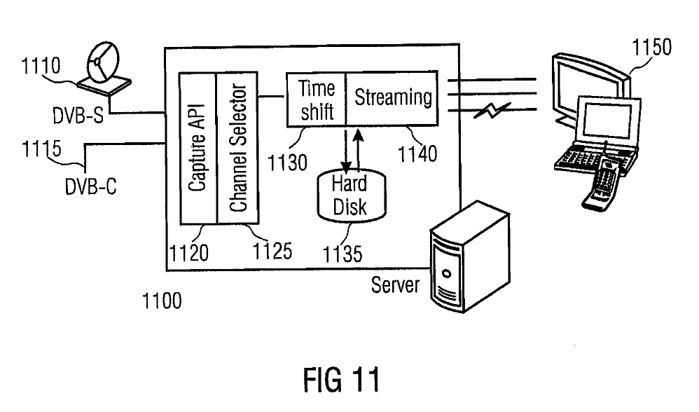

FIG. 11 shows an exemplified block diagram of an embodiment of a server apparatus.

FIG. 1 shows a server apparatus 100 for providing media data to client devices 101, 102, 103 and 104. The number of client devices is not limited. In an embodiment, there may only be a single client device 101. The server apparatus 100 comprises a data interface 110 for communicating with the client devices 101 to 104. Moreover, the server apparatus 100 comprises a user interface 120 for receiving a client device identification. The user interface 120 may be configured to directly communicate with the user 125. In embodiments, the user interface 120 may be realized by a keyboard, a mouse and a screen or touch-screen, where a user could directly select or enter a client device identification for selection. In other embodiments, the user interface may be adapted for communicating with other devices, for example, a client device in order to receive a client device identification from a user. In other embodiments the user interface may be a remote control or a button at the server apparatus 100.

The server apparatus 100 further comprises a controller 130 for selecting a client device 101 based on the client device identification. A data forwarder 140 is adapted for providing the media data to the selected client device 101 through the data interface 110.

In embodiments the data forwarder may be adapted for providing media data of a media session to a first client device through the data interface, the user interface can be adapted for receiving a second client device identification, the controller can be adapted for selecting the second client device based on the second client device identification and the data forwarder can be adapted for providing the media data for continuing the media session to the second client device through the data interface. In an embodiment a media session, as e.g. a video steaming, can be continued on the second client device, while the streaming to the first client device is stopped. The server apparatus 100 then carries out a redirection of the media session. In other embodiments the media session may be continued on the first and the second device as parallel media sessions, then the server apparatus 100 carries out a copying of the media session.

Embodiments of the server apparatus 100 can therefore enable a user to select a certain client device, where a client device may be a TV set, a laptop computer, a PDA, a cell phone, etc. to play-out a certain media data, which is then forwarded by the server apparatus 100, respectively, the data forwarder 140 to said client device through a data interface 110. The data interface may be a wireless interface or a wired interface. In other embodiments, the server apparatus 100 may further comprise a second data interface for communicating with the storage device for the media data. In embodiments, the server apparatus may be adapted to store media data on, for example, a hard drive. In another embodiment, the second data interface may be configured to communicate with a storage device in one embodiment, for example, through a wireless or wire line interface to a media data server.

In embodiments, the user interface 120 may be adapted for receiving the client device identification through one of the client devices 101 to 104, where the number of client devices is not limited and four client devices are considered here only for exemplary purposes. In such an embodiment, a user is enabled to redirect a media session, for example, from his mobile phone to his stereo. Another example scenario would be redirecting a video stream from his personal computer to his TV set, etc. The controller 130 may be adapted for pausing a provision of media data based on an information received from the user interface 120. In embodiments, a user may be able to pause a certain multimedia session and continue said session on a different device. Inbetween, the controller 130 may pause provision of said media data.

In other embodiments, the data forwarder 140 may be adapted for providing the media data to multiple client devices. The server apparatus 100 may then be adapted to run parallel multimedia sessions to multiple client devices, for example, in a scenario where a certain audio data is played in multiple rooms or a certain TV program is watched in different rooms.

The data interface 110 may be adapted for communicating with the client devices 101 to 104 using, for example, the UPnP (UPnP=Universal Plug and Play) protocol, the HTTP (HTTP=Hyper Text Transfer Protocol), TCP (TCP=Transport Control Protocol), etc. In embodiments, the server apparatus 100 may further comprise a receiver for the media data as, for example, a DVB-T, DVB-C, DVB-H, a satellite receiver, an IP-connection, etc. Moreover, the server apparatus may comprise a storage device for buffering the media data to enable, for example, time shifting or replay of received live media data.

FIG. 2 shows a receiver apparatus 200 for receiving media data from a server device 204 and for providing the media data to a play-out device 206. The server device 204 may be a server apparatus 100, as described above. The receive apparatus 200 comprises a data interface 210 for communicating with the server device 204 and for receiving the media data, it further comprises a user interface 240 for receiving a user information. In FIG. 2, the data interface 210 is exemplified as a wireless interface, indicated by two antennas. In embodiments the data interface 210 can be any wireless or wired interface enabling data exchange, for example an Internet connection is also conceivable. The receiver apparatus 200 further comprises a means 220 for processing the media data for adaptation to the play-out device 206 and a play-out interface 230 for providing the media data to the play-out device 206, the means 220 for processing is further adapted for controlling the data interface 210 and the play-out interface 230 based on the user information. In embodiments, the receiver apparatus 200 may be integrated in a play-out device 206. In another embodiment, the receiver apparatus 200 may be separated as, for example, in the scenario where a TV is connected to a box, in which a receiver apparatus 200 is implemented.

In embodiments, at least a part of the user information received from the user interface may be forwarded to the server device 204, a user may select a certain media content to be provided, pause, forward, rewind, play, redirect or copy media content to other receivers, etc. In another embodiment, the user information, or part of the user information, can also be forwarded to another receiver apparatus, to which a stream of media data may be redirected or to which a copy of the media data may be sent. The data interface 210 may be adapted for communicating using UPnP, HTTP, TCP, etc. The receiver apparatus may be integrated in a television set, a PDA, a cell phone, a PC, a laptop. In a home environment system, embodiments of the server apparatus 100 and the receiver apparatus 200 may be implemented, constituting a system for distributing and administering media data in a home environment.

Some embodiments can allow for sending any type of media stream to any defined client device/client software in a Home Media Network with instant connecting viewing options of the same program/channel/track that was listened to at a server side, as it is, for example, defined under the trademark of Nero SendMedia@Home. In an embodiment of a server apparatus 100, for example, Nero MediaHome, as a parent application of SendMedia@Home, can enable a user to name the devices, i.e. the client devices, for example, according to the room they are located in, for instance, bedroom, office, kids, etc. Embodiments of the receiver apparatus 200 may reside within the client devices. SendMedia@Home may then enable the user to pause a given media on the server, i.e. a server apparatus 100 and send the stream to a defined client, a receiver apparatus 200, by maintaining the actual position of the send track until it is accessed via a play command as user information at the client side, i.e. at the receiver apparatus 200. The server apparatuses 100 and the receiver apparatuses 200 may be co-located with client devices and the media data may include all types of media and TV as, for instance, audio, video, images, TV (including time-shifting, CD/DVD, collections/play lists, etc.).

At the server apparatus 100, client devices, i.e. receiver apparatuses 200, may be selected for provision of media data by a user. For instance, Nero MediaHome, as a parent application of SendMedia@Home, allows for deactivating clients, so that defined addresses, for instance, rooms, can be disconnected from or connected to streaming access. Thus, embodiments may enable parental control and monitoring. Moreover, as an example, on the server side access points for activating SendMedia@Home will be available in Nero Home, Nero ShowTime and Nero MediaHome.

In embodiments, the SendMedia@Home functionality may be split into three roles, the server or server apparatus 100, the actor and the receiver or receiver apparatus 200. Any device within a home network may overtake one or more roles depending on what parts of a software or hardware implementation are available. FIG. 3 illustrates a sample collection of devices, which may be involved in such communication in a home environment. FIG. 3 shows a television and set-top-box 310, a smart phone 320, a desktop PC 330, a laptop computer 340, a mobile phone 350 and a hand-held or PDA 360, which shall exemplify devices participating in the home environment. The list of devices as well as the number of devices participating in such a communication environment is not limited, as all kinds of different user terminals and media devices are conceivable.

In the following, an example scenario shall be described as use case #1. Use case #1 will be used to further explain the details of the mentioned roles. The scenario used shall not be understood in any limiting way, but serve for explanatory purposes.

FIG. 4a shows a scenario with a television and set-top-box 310 and a desktop PC 330. It is assumed that a user is previewing a movie on his desktop PC 330. After a while of watching, the user decides that he wants to continue watching on his television 310 in the living room. The desktop PC 330 serves as a server apparatus 100 and the television 310 serves as a receiver apparatus 200. The user may press a dedicated remote control button “Send To” or a menu action in the playback application which, at first, runs on the desktop PC 330. In this example, the server apparatus 100 comprises a user interface in terms of a keyboard, mouse or touch screen at the personal computer 330. As a reaction to the user pressing the “Send To” button, the playback media file, i.e. the movie, is getting paused immediately. A selection screen may be displayed, as exemplified in FIG. 4b. From the selection screen, the user may choose where to actually send the media file. As an example in FIG. 4b, it is assumed that the user selects “Television (Living Room)”, i.e. the television 310.

As the target device, i.e. the receiver apparatus 200, in this example the television and set-top-box 310, gets chosen by the user, a playback application triggers a connection to it through a data interface, which is exemplified by a wireless interface in FIG. 4a by an antenna. FIG. 5a illustrates this step.

In other words, the server apparatus 100 receives through the user interface 120, a client device identification, which, in this example, identifies the client device 310, i.e. the TV in the living room. After the user has entered said client device identification, the controller 130 selects the client device 101, i.e. the TV with the set-top-box 310, and builds up a connection. After the connection is established, a remote playback can be initiated and data can be forwarded by the data forwarder 140 from the server apparatus 100, i.e. the desktop PC 330, to the receiver apparatus 200, i.e. the television and set-top-box 310. The receiver apparatus 200, i.e. the TV and set-top-box 310 communicates with the server through its data interface 210, which is exemplified in the scenario through a wireless interface. In the example, the receiver may reside in the set-top-box and the play-out device may be the television. Therewith, between set-top-box and television, resides the play-out interface 230 for providing the media data to the play-out device, i.e. the television.

The devices in the example scenario depicted in FIGS. 4a and 5a overtake the following roles. The desktop PC 330 is both “actor”, as it initiates the connection and the remote playback, and “server”, as the media is located on it and will be streamed from there. The set-top-box connected to the television overtakes the receiver role.

In one embodiment, the connection may be initiated through the standardized UPnP AVTransport service via the AVTransport service, via the AVTransport::SetAVTransportURI, the AVTransport::Play, and the AVTransport::Pause actions, etc.pp. The UPnP protocol is used as an example in order to provide an implementation of the communication protocol between the server apparatus 100 and the client devices or receiver apparatuses 200. The UPnP is a set of computer network protocols prorogated by the UPnP forum. The goals of the UPnP are to allow devices to connect seamlessly and to simplify the implementation of networks in home environments that enable data sharing, communications, entertainment, etc. The UPnP architecture allows peer-to-peer networking of personal computers, network appliances, wireless devices, etc. and it is a distributed, open architecture based on TCP/IP, UDP (UDP=Universal Datagram Protocol) and HTTP.

In the example scenario, the receiving device, i.e. the receiver apparatus 200 or the television and a set-top-box 310 will, again, immediately switch to playback mode or display the media data sent in pause mode or display a message first to allow the user to cancel the send operation in advance. At the same time playback stops on the desktop PC 330, i.e. the actor device. The streaming itself may be handled by an appropriate standard protocol, like HTTP or RTP/RTSP (RTP=Read Time Protocol, RTSP=Rear Time Secure Protocol), as it is exemplified in FIG. 5b where HTTP-streaming is utilized.

As already mentioned above during the initial state of the media transfer, the play-out may be paused. This may include the live TV, which is also halted unless the user chooses to continue the playback, enabling the so-called time-shifting feature. This allows the user to seamlessly continue playback on the desired receiver apparatus 200. In order to enable said time-shifting feature, the server may comprise a storage device or an interface to a storage device, where the live TV data is buffered.

FIG. 6a depicts another example scenario, which shall serve as a sample use case #2, wherein a network attached storage device 610 provides media data through HTTP streaming to a hand-held device 620. The network attached storage device 610 acts as server apparatus 100 and the hand-held device 620 acts as a receiver apparatus 200. The scenario depicted in FIG. 6a further shows a Hi-Fi stereo 630 to which the HTTP streaming shall be redirected. The scenario depicted in FIG. 6a is similar to the first one. However, the following example shall demonstrate that the actor and server roles might be overtaken from different devices seamlessly. In the embodiments, the interaction between the devices, i.e. client devices, can be fully transparent for the user.

According to FIG. 6a, it is first assumed that the user listens to a newly downloaded song directly on his hand-held device 620, for example, a PDA. The media file itself is located on the network attached storage device 610 somewhere in the home network and streamed through HTTP, RTP/RTSP or any other applicable protocol conceivable, directly onto the PDA. After a while of listening, the user decides that he wants to continue the playback on his stereo 630. Therefore, he chooses the “Send To” menu action in the playback application on the PDA. The PDA acting as a receiver apparatus 200 provides the user interface in this example and allows the user to chose from a menu. An example for such a menu is depicted in FIG. 6b in the form of a sample selection screen, as it could be shown in the PDA. Following the example, the user chooses “Hi-Fi (Living Room)”.

The playback media file is getting paused immediately after pressing this button, i.e. in this embodiment, at least parts of the user information get forwarded to the server apparatus or network attached storage device 610, which, in turn, pauses the provision of the media data. The selection screen gets displayed and the user can chose where to actually send the media file to. FIG. 7a shows that the hand-held 670 connects to the stereo 630 in order for the stereo 630 to prepare a playback. In another embodiment, this communication between the client devices can be carried out through the server apparatus 100 or, in this example through the network attached storage device 610. In this case, the hand-held 620 would send a preparation message for the stereo as part of user information to the network attached storage device 610, which, in turn, forwards the message to the stereo 630.

In line with the first use case, the stereo 630 can begin the playback of the media file, waiting in pause mode however, until the user wants to continue playback. Once the user indicates that he wants to continue playback, the network attached storage device 610 continues streaming the media data to the stereo 630, as illustrated in FIG. 7b.

In another example scenario, the user may want to continue the playback also on the original device, i.e. on the handheld 620, so it could be watched or listened on both devices, i.e. the stereo 630 and the handheld 620 simultaneously. This example scenario is depicted in FIG. 8. The network attached storage device 610 would then stream the media data to both devices, the Hi-Fi stereo 630 and the handheld 620. The parallel provision of the media content can then be triggered by either the handheld device 620 or the stereo 630. Both devices may comprise a user interface where such provision could be activated.

The SendMedia@Home technology is built upon well-defined and standardized protocols, like UPnP and HTTP in one embodiment. In this embodiment, the devices within a home network communicate and control each other using the UPnP protocol, namely the standardized UPnP AVTransport, the UPnP ConnectionManager and the UPnP ContentDirectory services.

Embodiments can enable the integration of these well-known principles into a smooth and seamless user experience. For example, the SendMedia@Home functionality then enables to redirect any kind of media, for example, video including TV, audio, pictures, but also documents, spreadsheets, etc. from the current playback device to any other device within the home network, whereas playback will continue on exactly the same time position where it was before. Embodiments of the receiver apparatus 100 receive redirection information or also copy information for parallel media streams and provide the media data to the desired receiver apparatuses 200 respectively client devices. This provides the advantage for the user not only to take the media with him anywhere he goes, but also to send the media everywhere he wants to go. The used protocols and interfaces between the server apparatus 100 and the receiver apparatuses 200 are not limited, they may be wireless in terms of a wireless local area network or also in terms of mobile radio services. Embodiments enable one of the main use cases, which applies to home network scenarios. However, embodiments are not limited to local area networks, but can also be used within wide area networks. The UPnP functionality as, for example, calling service actions and the device discovery in this case can be tunneled, for example, for an HTTP connection. Embodiments therewith allow the user to send media, for example, from a stereo to his mobile phone and leave his home while the music keeps playing even after having left the home network coverage.

In the above two use cases for simplicity reasons, only redirecting a provision of media data from one device to another was discussed. However, embodiments are not limited to interactions between only two devices. For example, in the embodiment of SendMedia@Home, users are enabled to watch a single media file or especially a TV stream on several devices simultaneously, while keeping the possibility to pause, fast-forward, fast-backward, etc. on each of them individually. FIG. 9 shows such a scenario, wherein a server 910, a mobile 920, a home office laptop 930 and a TV set in the living room 940 interact with each other. In the scenario depicted in FIG. 9, the server 910 is connected to a TV receiver 950. The TV media data which is provided from the TV receiver 950 to the server 910 is stored and distributed from the server. In the example depicted in FIG. 9, it is assumed that the media data is provided to the mobile 920, the home office laptop 930 and the living room TV 940. Each of these devices may pause, fast-forward, fast backward, etc. the media data, as the server provides time-shifting capability, enabling to modify each of the media data stream services. In another embodiment, the server 910 may as well synchronize all streaming services provided to the mobile devices or receiver apparatuses 200. For example, if a video conference is taking place to which several people want to listen to, the server 911 may provide synchronous data (audio and/or video).

In embodiments enabling the SendMedia@Home functionality, the current playback device or the actor can be aware of the SendMedia@Home technology and could offer the “Send-To” functionalities either via a dedicated remote control button if the device supports that or a graphical or textual menu item in the device's user interface or any other user interface. Multiple user interfaces are conceivable and embodiments are not limited to the above-mentioned examples. It is, for example, conceivable to remote control server functionalities by a mobile phone, the mobile phone providing the user interface for any action that may be taken at the server.

FIG. 10 shows an example of a message sequence chart illustrating a redirection of a data stream. In the following, the messages of FIG. 10 will be discussed from the top to the bottom where, in FIG. 10, four entities are considered, which are the user 1000, the actor 1010, the server 1020 and the receiver 1030. It is assumed that the user 1000 watches a media session, which is rendered/played by the actor 1010, to which the data are streamed via a streaming connection from the server 1020. The user decides to continue the multimedia session at a different device, here the receiver 1030. Therefore, the user presses the “Send Media” button, for example, on a remote control. The actor 1010 will then pause the playback and display a list of potential receivers. The user 1000 may then choose a specific receiver which, in this example, is the receiver 1030. The actor 1010 then initiates a connection to said receiver 1030, for example, through the UPnP AVT:SetAVTransportURI messages. Further UPnP messages may be utilized, for example in FIG. 10, the actor 1010 also provides seek to actual position :AVT:Seek( )- and initiate playback :AVT:Pause( )- messages. Optionally, the server 1020 can be informed by the actor through an according message.

Thereafter, the server 1020 continues the streaming to the receiver 1030, which starts the paused playback. For example, first a still frame is rendered and provided to the user 1000. In another embodiment, the receiver 1030 may directly continue without rendering a still frame. In this example, the user 1000 presses a “play button”, which creates a user information that is provided to the receiver 1030. The receiver 1030 then continues playback, the server 1020 continues the streaming, upon which the receiver 1030 continues rendering or playing the media to the user 1000. Optionally the server 1020 can be informed about the continuation or discontinuation of the streaming by the receiver 1030 or the user 1000.

FIG. 11 depicts a more detailed embodiment of a server apparatus 1100. The server apparatus 1100 is coupled to a DVB-S (DVB-S=DVB-Satellite) device 1110 and a DVB-C device 1115. The server apparatus 1100 comprises a capture API (API=Application Programming Interface) 1120 and a channel selector 1125. The server apparatus 1100 further comprises a time shifter 1130 and a streaming entity 1140 where the time shifter 1130 and the streaming entity 1140 are coupled to a hard disk 1135. The streaming entity 1140 is coupled to a data interface through which media data can be provided to client devices 1150. The streaming entity 1140 acts as a data forwarder, the hard disk 1135 realizes a storage device.

The embodiment depicted in FIG. 11 gives some more in-depth overview of the embodiment of Nero TV-server functionality. The TV signal can be captured by the server apparatus 1100 and can be recorded directly to the hard disk 1135 or hard disk buffer. This allows multiple clients to access the same recording, i.e. the same buffer and freely seek within its boundaries.

This functionality goes hand-in-hand with the SendMedia@Home technology already described. As soon as a “Send-To”-button or menu action is invoked, a current playback can be halted and the target receiver device can continue on the exact same time position of, for example, a TV stream, so that a user can watch TV shows not only in real-time, but also time-shifted, whereas the maximum number of minutes shifted can be freely configured in embodiments and is only limited by the available hard disk space. In contrast to other solutions, only a single time shift buffer per capture device may exist on the server. The receiver apparatuses or client devices do not need to have any hard disk built in as, in embodiments, the server will take care about buffering. In combination with the ability to stream the TV signal of a single tuner card to multiple clients simultaneously, this functionality allows a seamless TV experience within the network. By installing multiple TV adaptors in the server, the flexibility can be even improved, as multiple receivers can watch different TV shows at the same time. However, if they are still playing back the same TV channel, they will share a single TV adaptor and a single time-shift buffer.

Embodiments of the present, therewith, provide the advantage that a higher flexibility is achieved than with conventional systems. Media streams can be shifted, redirected and/or copied between network nodes of a home network in other embodiments, even within wide area networks. The user's experience and, along with the experience, also the user's satisfaction are significantly enhanced with the embodiments, since provision of media data, which can be provided to multiple end terminals, can be seamlessly adapted to the user needs, i.e. to the user location and mobility conditions.

Depending on certain implementation requirements of the inventive methods, the inventive methods can be implemented in hardware or in software. The implementation can be performed using a digital storage medium, in particular, a disk, a DVD or a CD having electronically readable control signals stored thereon, which co-operate with programmable computer systems such that the inventive methods are performed. Generally, the present invention is therefore a computer program product with a program code stored on a machine-readable carrier, the program code being operated for performing the inventive methods when the computer program product runs on a computer. In other words, the inventive methods are, therefore, a computer program having a program code for performing at least one of the inventive methods when the computer program runs on a computer.

In the following a list of references to UPnP is provided:
UPnP Implementers Corporation
http://upnp-ic.org/
UPnP Technology Q&A
http://upnp-ic.org/docs/UPnP %20Q-A %205-16-2003.pdf
AV Media Server V1.0
http://www.upnp.org/standardizeddcps/documents/MediaServer 1.0.pdf
AV Media Renderer V1.0
http://www.upnp.org/standardizeddcps/documents/MediaRenderer1.0 000.pdf
AVTransport Service V1.0
http://www.upnp.org/standardizeddcps/documents/AVTransport1.0.pdf
ContentDirectory Service V1.0
http://www.upnp.org/standardizeddcps/documents/Content Directory1.0.pdf
RenderingControl Service V1.0
http://www.upnp.org/standardizeddcps/documents/RenderingControl1.0.dpf

1. Server apparatus for providing media data to client devices, comprising:
a data interface for communicating with the client devices;
a user interface for receiving a client device identification;
a controller for selecting a client device based on the client device identification; and
a data forwarder for providing the media data to the selected client device through the data interface.

2. Server apparatus of claim 1, wherein the data forwarder is adapted for providing media data of a media session to a first client device through the data interface, the user interface is adapted for receiving a second client device identification, the controller being adapted for selecting the second client device based on the second client device identification and the data forwarder being adapted for providing the media data for continuing the media session to the second client device through the data interface.

3. Server apparatus of claim 1, further comprising a second data interface for communicating with a storage device for the media data.

4. Server apparatus of claim 1, wherein the user interface is adapted for receiving the client device identification through a client device.

5. Server apparatus of claim 1, wherein the controller is adapted for pausing a provision of media data based on an information received from the user interface.

6. Server apparatus of claim 1, wherein the data forwarder is adapted for providing the media data to multiple client devices or for redirecting media data between different client devices.

7. Server apparatus of claim 1, wherein the data interface is adapted for communicating with the client devices using UPnP (UPnP=Universal Plug and Play), HTTP (HTTP=Hyper Text Transfer Protocol), TCP (TCP=Transport Control Protocol), IP (IP=Internet Protocol) or UDP (UDP=Universal Datagram Protocol).

8. Server apparatus of claim 1, further comprising a receiver for the media data.

9. Server apparatus of claim 8, wherein the receiver is adapted for receiving a DVB-T (DVB-T=Digital Video Broadcast-Terrestrial), DVB-C (DVB-C=DVB-Cable), DVB-H (DVB-H=DVB-Handheld) or DVB-S (DVB-S=DVB-Satellite).

10. Server apparatus of claim 9, wherein the receiver is adapted for buffering the media data.

11. Method for providing media data to client devices, comprising the steps of:
communicating with the client devices;
receiving a client device identification;
selecting a client device based on the client device identification; and
providing the media data to the selected client device.

12. Computer program having a program code for performing the method of claim 11 when the computer program runs on a computer.

13. Receiver apparatus for receiving media data from a server device and for providing the media data to a play-out device, comprising:
a data interface for communicating with the server device and for receiving the media data;
a user interface for receiving a user information;
a means for processing the media data for adaptation to the play-out device; and
a play-out interface for providing the media data to the play-out device,
wherein the means for processing is further adapted for controlling the data interface and the play-out interface based on the user information.

14. Receiver apparatus of claim 13, further adapted for forwarding at least a part of the user information to the server device.

15. Receiver apparatus of claim 13, further adapted for forwarding at least a part of the user information to another receiver apparatus.

16. Receiver apparatus of claim 13, wherein the data interface is adapted for communicating using UPnP, HTTP, TCP, IP or UDP protocols.

17. Method for receiving media data from a server device and for providing the media data to a play-out device, comprising the steps of:
communicating with the server device;
receiving a user information;
receiving the media data from the server device;
processing the media data for adaptation to the play-out device; and
providing the media data to the play-out device based on the user information.

18. Computer program having a program code for performing the method of claim 17 when the program code runs on a computer.

19. Television set comprising a server apparatus according to one of the claims 1 to 10 or a receiver apparatus according to one of the claims 13 to 16.

20. Television set-top-box comprising a server apparatus according to one of the claims 1 to 10 or a receiver apparatus according to one of the claims 13 to 16.

21. Personal Digital Assistant (PDA) comprising a server apparatus according to one of the claims 1 to 10 or a receiver apparatus according to one of the claims 13 to 16.

22. Cell phone comprising a server apparatus according to one of the claims 1 to 10 or a receiver apparatus according to one of the claims 13 to 16.

23. Personal computer comprising a server apparatus according to one of the claims 1 to 10 or a receiver apparatus according to one of the claims 13 to 16.

24. Laptop computer comprising a server apparatus according to one of the claims 1 to 10 or a receiver apparatus according to one of the claims 13 to 16.

25. System comprising a server apparatus according to one of the claims 1 to 10 and a receiver apparatus according to one of the claims 13 to 16.
